(19) United States
(12) Patent Application Publication
(10) Pub. No.: US 2025/0341407 A1
(43) Pub. Date: Nov. 6, 2025

(54) PROCESS AND SYSTEM FOR THE INDIRECT IDENTIFICATION OF WEAR OF A SLIDING ENERGY CHAIN

(71) Applicant: IGUS GMBH, Köln (DE)

(72) Inventors: Richard HABERING, Köln (DE); Konstantin SCHMER, Köln (DE)

(21) Appl. No.: 18/855,461

(22) PCT Filed: Apr. 24, 2023
(86) PCT No.: PCT/EP2023/060673

§ 371 Date: Oct. 9, 2024

(30) Foreign Application Priority Data
Apr. 25, 2022 (DE) 10 2022 109 964.4
Oct. 28, 2022 (DE) 10 2022 128 793.9

(51) Int. Cl. G01D 5/24

(52) U.S. Cl. CPC G01D 5/24

(57) ABSTRACT

A system for indirect wear identification on an energy chain. The system comprises a sensor arrangement preferably arranged stationary and an evaluation device, which is signal-connected to the sensor arrangement. The sensor arrangement is arranged and is set up to generate, depending on at least one feature of the chain links which occurs or is detectable repeating periodically, in particular corresponding to the chain pitch of the energy chain, during movement of the energy chain relative to the sensor arrangement, corresponding output signals, which the evaluation device evaluates.

### FIELD

The invention relates generally to a system and a process for monitoring or condition monitoring of a movable or dynamic line guide, in particular an energy chain, for guiding at least one line, such as e.g. a cable, hose or the like, between a stationary fixed point and a driver mobile relative thereto, typically on a mobile plant part or machine part.

The invention relates in particular to a system and a process for the indirect identification of wear during operation of the energy chain, with the result that predictive maintenance is made possible.

### BACKGROUND

During movement the energy chain typically forms a stationary lower run, a movable upper run and, in between, a deflecting arc moving with it. The invention relates in particular to energy chains with a sliding upper run for long travels.

For wear identification, solutions are known in which particular sensor modules are built into the line guide device or energy chain, such as proposed for instance in WO 2017/129805 A1 or WO 2019/201482 A1. However, these solutions require structural changes on the energy chain and available installation space inside the receiving space for the lines. A further approach to monitoring wear was proposed in WO 2021/043668 A1, but here too structural measures on the energy chain are needed, or this approach is only suitable for sliding energy chains with sliding shoes. In addition, an approach to monitoring wear was presented in EP 1 521 015 A2, in which it is ascertained, with reference to a wear element with a predetermined breaking point, whether there is critical wear of the chain. The predetermined breaking point there is the indicator which is used for a critical wear condition of the chain.

In DE 20 2016 000 501 U1 an approach like in WO 2017/129805 A1 was presented, in which a wear element is formed as a transponder. In DE 20 2016 107 317 U1, or WO 2018/115528 A1, an approach was presented in which a progression of the chain is monitored, which is not readily suitable for wear identification, however.

A structurally simple solution for the identification of wear during operation of different energy chains which is as widely usable as possible and can be implemented as far as possible without structural measures, or modification or change, with an existing energy chain is desirable. In particular, a wear monitoring relating to the typical articulated connections between chain links is to be made possible without the need to modify the energy chain for this.

### SUMMARY

The invention starts from a system for indirect wear identification on an energy chain. The energy chain typically serves to guide at least one line, such as e.g. a cable, hose or the like, between a stationary fixed point and a driver mobile relative thereto, wherein the energy chain is movable, forming a stationary lower run, a movable upper run and, in between, a deflecting arc. The energy chain is implemented and arranged in particular, as is typical in the case of long travels, with a sliding upper run. By a sliding upper run is also meant in the present case an upper run rolling on the lower run.

It is proposed that the sensor arrangement comprises at least two sensors, which are in each case arranged and set up such that, depending on at least one feature which occurs or is detectable repeating periodically, in particular corresponding to the chain pitch of the energy chain, during movement of the energy chain relative to the sensor arrangement, the sensors generate corresponding output signals, which the evaluation device evaluates, and that the evaluation device is set up in order to detect and evaluate the temporal behaviour of the output signals of the individual sensors. The system preferably has a sensor arrangement preferably arranged stationary and an evaluation device, which is signal-connected to the sensor arrangement.

According to the invention the sensor arrangement is arranged and set up to generate, depending on at least one feature which occurs, in particular is detectable, repeating periodically, in particular corresponding to the chain pitch of the energy chain, during movement, in particular travelling, of the energy chain relative to the sensor arrangement, corresponding output signals, which the evaluation device evaluates. In particular, the invention allows a detection of a time response of the energy chain to be performed and advantageously to be evaluated by means of at least two sensors, e.g. for determining increasing wear, which can be indirectly identifiable by change in the time response.

The feature can be in particular a structural feature of the energy chain, in particular of the individual chain link. It is preferably an inherently present structural feature of the energy chain which occurs repeating in the chain's longitudinal direction. The structural feature can occur repeatedly multiple times over the entire length of the chain, e.g. can be provided on every chain link or every second chain link and e.g. over almost the entire length between the end fastenings.

The system is preferably arranged and set up for indirect wear identification on at least one chain link of the energy chain, preferably for the identification of wear on a connection of at least two chain links of the energy chain. The energy chain preferably has a plurality, such as for example a few tens, or well over a hundred, of chain links, which are preferably formed all structurally identical (with so-called cranked plates or fork plates) or alternately structurally identical (e.g. with alternating inner and outer plates), where appropriate apart from end-side end connection links.

The invention provides many advantages. In particular, a wear condition of individual chain links can advantageously be identified. This allows only parts of the energy chain to be replaced in a targeted manner during maintenance or e.g. chain links under higher strain to be swapped with chain links under less strain during maintenance. Thus, e.g. the overall lifespan or sustainability of the energy chain can be increased.

The system for indirect wear identification is preferably arranged on the energy chain, between a stationary fixed point of the energy chain and a driver of the energy chain mobile relative thereto.

At least one end of the energy chain is typically mobile, in particular movable, along a longitudinal axis of the energy chain, in particular with respect to at least one further end of the energy chain. The stationary fixed point of the energy chain is preferably arranged at one end of the energy chain. The driver of the energy chain is preferably arranged at another end of the energy chain. The driver typically forms one end of the energy chain. Theoretically, the energy chain is divisible into at least three different areas during movement. One of the at least three areas is preferably a stationary lower run, which extends from one end, in particular the end at which the stationary fixed point is arranged, of the energy chain to the deflecting arc and which is in particular formed by a part of the energy chain extending parallel to the longitudinal axis of the energy chain. The area of the energy chain which forms the stationary lower run is preferably formed stationary only in relation to the end at which the stationary fixed point is arranged.

The system for indirect wear identification is preferably arranged at the fixed point in an imaginary extension of the stationary lower run, in such a way that the mobile upper run moves past on, in particular over, the sensor arrangement of the system and/or moves through the detection area of the sensor arrangement.

One of the at least three areas is thus preferably a movable upper run, which extends from one end, in particular the end at which the driver is arranged, of the energy chain to the deflecting arc and which is in particular formed by a part of the energy chain extending parallel to the longitudinal axis of the energy chain. One of the at least three areas is preferably a deflecting arc which is arranged between the other areas of the energy chain, preferably the stationary lower run and the movable upper run, and which in particular forms an arc (so-called deflecting arc) of the energy chain running over an approximately 180° angular dimension. The upper run is preferably mounted sliding on the lower run. The upper run can alternatively or additionally be mounted rolling, in particular by means of at least one rolling element, on the lower run—wherein by the collective term sliding upper run in the present case is meant a rolling upper run.

The system preferably has a sensor arrangement arranged stationary, in particular with respect to the energy chain. The system preferably has an evaluation device implemented and arranged separate therefrom. The evaluation device is preferably signal-connected to the sensor arrangement, in particular for a data transmission, preferably at least from the sensor arrangement to the evaluation device. During operation the sensor arrangement preferably transmits a continuous signal to the evaluation device, for example in real time or as a periodic signal with a suitable transmission frequency of at least 20 Hz, preferably at least 50 Hz.

The sensor arrangement is preferably arranged and set up to generate, depending on at least one feature of the energy chain, corresponding output signals, which the evaluation device evaluates. The sensor arrangement is preferably set up to generate, depending on at least one feature of the energy chain, corresponding output signals and to send them to the evaluation device. The feature of the energy chain preferably occurs repeating periodically, in particular corresponding to the chain pitch of the energy chain, during movement, in particular travelling, of the energy chain relative to the sensor arrangement. The at least one feature of the energy chain is preferably a feature which is selected such that it occurs on every chain link of the energy chain, in particular in each case at the same point on the chain link.

The feature of the energy chain is preferably detectable repeating periodically, in particular corresponding to the chain pitch of the energy chain, during movement, in particular travelling, of the energy chain relative to the sensor arrangement. For example, the at least one feature of the energy chain can be chosen as a respective element of the chain links lying inside in relation to the deflecting arc. For example, the at least one feature of the energy chain can be formed as a lettering on the chain links.

A cross bar or a constituent of the cross bar which is inherently provided on every or every nth chain link is particularly preferably utilized as the at least one feature of the energy chain. The cross bar is inherently or per se optically and/or electromagnetically detectable without a change being necessary.

As a supplement or alternative, the at least one feature of the energy chain can be provided as a feature that can be added with little effort. Thus, a code, such as in particular a barcode and/or QR code, can e.g. be formed on the chain links. For example, the at least one feature of the energy chain can be formed as an optical element on the chain links, in particular to generate an optical signal, preferably an electromagnetic signal, for example in the visible optical spectrum, preferably in the infrared spectrum, particularly preferably outside the visible spectrum, particular preferably in the in the non-visible spectrum.

Other designs also come into consideration. Thus, the sensor arrangement can be set up to detect at least optical, preferably electromagnetic, signals. For example, the at least one feature of the energy chain can be formed as an acoustic element of a chain link, in particular to generate an acoustic signal, for example in the audible signal frequency spectrum, preferably in the non-audible signal frequency spectrum, e.g. in the ultrasonic range, alternatively in the infrasonic range. In particular, the sensor arrangement can be set up to detect at least acoustic signals, in particular sound waves or structure-borne sound. Here, a driving noise inherently generated during movement can also be monitored without particular or additional acoustic elements being provided.

The sensor arrangement is preferably formed to monitor the energy chain, in particular the at least one feature of the energy chain, preferably of every chain link of the energy chain, during movement of the energy chain. The sensor arrangement preferably has at least one, preferably at least two, sensor(s), which is/are formed to detect at least one feature of the energy chain during movement of the energy chain.

The evaluation device is particularly preferably formed to determine a distance between two chain links of the energy chain from the output signals which the evaluation device receives from the sensor arrangement.

The evaluation device is preferably formed to determine an instantaneous velocity of the chain links, for example of individual chain links or in each case of two chain links, of the energy chain from the output signals which the evaluation device receives from the sensor arrangement.

The evaluation device is preferably formed to standardize the determined distances between in each case two chain links by means of determined instantaneous velocities, in particular of the considered chain links.

The evaluation device is particularly preferably formed to determine a wear condition of the energy chain, in particular of the chain links of the energy chain, from determined, in particular standardized, distances between the chain links of the energy chain.

In a development the evaluation device is formed to determine a change in the instantaneous velocity of the chain links of the energy chain from the output signals which the evaluation device receives from the sensor arrangement. Here, the evaluation device can be formed to determine a wear condition of the energy chain, in particular of the chain links of the energy chain, from determined changes in the instantaneous velocity of the chain links of the energy chain. For example, a resumption of speed during a change in direction of the energy chain between chain links connected with play due to wear is slower than between the chain links connected with play due only to manufacturing tolerance in the as-new condition.

A conclusion as to the wear condition of the connection of two chain links can be drawn e.g. from an acceleration of individual chain links.

In particular, from a frequency, preferably a frequency change, of the signals a determination, which is in particular advantageously relatively precise, of the speeds and accelerations of the chain links can be achieved by the sensor arrangement. In particular, frequency effects, such as for example a Doppler effect, can be used in order to achieve a determination, which is in particular advantageously particularly precise, of the speeds and accelerations of the chain links. In particular, the evaluation device can be formed to determine and preferably to average the wear condition of the energy chain, in particular of the chain links of the energy chain, from the, in particular standardized, distances between the chain links of the energy chain and from determined changes in the instantaneous velocity of the chain links of the energy chain.

By a “longitudinal axis” of an object is meant here in particular an axis which runs parallel to a longest edge of a smallest, imaginary, geometric cuboid, which only just completely surrounds the object, and preferably runs through a geometric centre of the object, in particular the cuboid.

The evaluation device comprises in particular at least one processor and/or at least one processor unit, at least one memory unit, and an operating, control and/or calculation program stored in the memory unit.

The at least two sensors, in particular of the sensor arrangement, are preferably in each case arranged in such a way that the sensors detect at least one feature which occurs repeating periodically, in particular corresponding to the chain pitch of the energy chain, during movement of the energy chain relative to the sensor arrangement. The at least two sensors, in particular of the sensor arrangement, are preferably in each case set up to generate, depending on the at least one feature, corresponding output signals. The evaluation device is preferably formed to evaluate the output signals. The evaluation device is particularly preferably set up to detect and evaluate the temporal behaviour of the output signals of the individual sensors.

Through the design according to the invention of the detection system for indirect wear identification on an energy chain, an advantageous precise monitoring of the wear condition of the energy chain can be achieved. In particular, an advantageously cost-effective early identification of an imminent breaking of the energy chain can be achieved.

Moreover, it is proposed that the at least two sensors are spaced apart from each other in the movement direction and arranged and set up in such a way that each of the sensors detects the presence of passing cross bars of the energy chain and outputs a corresponding output signal. The sensor arrangement preferably comprises several sensors spaced apart from each other in the movement direction, and is arranged in such a way that each of the sensors detects the presence of passing features of the energy chain, in particular cross bars, as the at least one feature of the energy chain, and outputs a corresponding output signal. The sensor arrangement preferably comprises several, preferably at least two, in particular at least three, sensors, which are preferably arranged spaced apart from each other in the movement direction of the energy chain, which are preferably arranged at least partially and/or at least completely offset relative to each other in the movement direction of the energy chain. Each of the sensors preferably in each case detects the presence of the considered at least one feature of the energy chain, for example passing cross bars. Each of the sensors preferably outputs an output signal corresponding to the detected presence or absence of the same at least one feature of the energy chain, for example of the passing cross bar. A detection, advantageously uninterrupted for a long period, of the at least one feature of the energy chain can be achieved.

Furthermore, it is proposed that the sensors are implemented as electromagnetic, in particular as capacitive, proximity sensors. The sensors of the sensor arrangement are preferably formed functionally identical and/or structurally identical.

The sensors of the sensor arrangement can as an alternative and/or supplement also be formed as inductive proximity sensors, as acoustic sensors, as light barriers, in particular as infrared light barriers or the like. An advantageously rapid, in particular high-resolution, monitoring of the energy chain can be achieved.

Moreover, it is proposed that at least two sensors of the sensor arrangement are arranged at a distance corresponding to the nominal (like-new) chain pitch and/or are arranged and set up to detect a feature which is dependent on the chain pitch. Preferably at least two sensors are provided and/or two sensors are arranged at a distance corresponding to the nominal, in particular in relation to a like-new, chain pitch. The sensor arrangement preferably has at least two sensors, which are arranged offset relative to each other along the movement direction, in particular along the longitudinal axis of the energy chain, at a distance corresponding to the nominal, in particular in relation to a like-new, chain pitch. The system for indirect wear identification on the energy chain preferably has the energy chain. Geometric centres of at least two sensors are preferably arranged offset relative to each other along the movement direction, in particular along the longitudinal axis of the energy chain, at a distance corresponding to the nominal, in particular in relation to a like-new, chain pitch. Two chain links can be detected simultaneously in order to be able to monitor a distance between the two chain links advantageously.

Furthermore, in a preferred development, it is proposed that the sensor arrangement is arranged stationary next to the fixed point in the movement direction of the energy chain. The sensor arrangement is preferably connected stationary to a carrier unit, in particular a rail unit, for the energy chain. The sensor arrangement for monitoring the upper run of the energy chain is preferably arranged stationary next to the fixed point in the movement direction of the energy chain. The stationary fixed point of the energy chain is typically arranged on the lower run of the energy chain. The sensor arrangement is preferably arranged offset relative to the stationary fixed point in the movement direction of the energy chain, in particular along the longitudinal axis of the energy chain. The rail unit preferably has at least two rails which are aligned parallel to the longitudinal axis of the energy chain, on which the energy chain is mounted and to which the sensor arrangement is mechanically connected or with regard to which the sensor arrangement is fixed in place. The stationary fixed point of the energy chain is preferably connected to the rail unit offset relative to the sensor arrangement along the longitudinal axis of the rail unit. An advantageous monitoring of the upper run during movement of the energy chain can be achieved.

Moreover, it is proposed that the evaluation device detects the instantaneous velocity of individual chain links from the temporal behaviour of the output signals and/or wherein the evaluation device comprises three sensors, wherein two sensors of the sensor arrangement are arranged at a distance corresponding to the nominal chain pitch and a third sensor is provided for identifying the direction of travel. The evaluation device preferably detects and/or determines the temporal behaviour of the output signals of the sensor arrangement, in particular of individual sensors, and/or detects, preferably determines, the instantaneous velocity of individual chain links from the output signals. The evaluation device preferably determines a wear condition of a connection of the two chain links from the distances, in particular in combination with the instantaneous velocities, of two neighbouring chain links. A third sensor, in particular of the sensor arrangement, is preferably formed to detect a direction of travel of the energy chain, which in particular corresponds to the instantaneous movement direction. A third sensor, in particular of the sensor arrangement, is preferably formed to identify, where appropriate directly, a direction of travel, in particular the instantaneous movement direction, of the energy chain and to communicate this to the evaluation device. Alternatively or additionally, the evaluation device can be formed to determine the direction of travel of the energy chain, which in particular corresponds to the instantaneous movement direction, from the output signals of the third sensor, where appropriate in cooperation with the output signals of one of the other two sensors. Alternatively or additionally, the instantaneous movement direction or direction of motion, e.g. forwards into the extended position or back into the retracted position, of the moving run of the energy chain can also be determined by or with reference to one or both first-named sensors.

A monitoring of the wear of an energy chain can advantageously be achieved independent of speed, in particular on the chain links most at risk according to experience, e.g. on the driver-side first third of the chain length. An inherent feature of the chain which occurs multiple times at least also in this first third preferably comes into consideration as structural feature in this respect.

Furthermore, it is proposed that the evaluation device evaluates the output signals of the sensor arrangement for deviations from a prestored behaviour or reference values of a like-new energy chain. The evaluation device preferably comprises at least one memory module, on which data with reference values or guide values which correspond to a like-new energy chain are stored, preferably prestored. An advantageously rapid determination of malfunctions of the energy chain can hereby be achieved.

Moreover, it is proposed that the evaluation device determines the distance between successive chain links by measuring time intervals between the periodic feature being detected and with reference to an instantaneous velocity detected in each case and preferably compares this with a predetermined, nominal chain pitch for the purpose of wear identification. The evaluation device preferably determines the standardized distance between successive chain links by measuring time intervals between the periodic feature being detected and with reference to an instantaneous velocity detected in each case. The evaluation device preferably compares each determined, and in particular standardized, distance with a predetermined, nominal chain pitch for wear identification on the corresponding chain links. An advantageously precise identification of wear of an energy chain can be achieved.

Furthermore, it is proposed that the evaluation device outputs a maintenance recommendation depending on the evaluation, in particular as a function of a currently detected distance between periodic features. The maintenance recommendation can be output e.g. to a superordinate computer. The evaluation device preferably has an output module, which is connected, e.g. by data processing technology, to a superordinate system and/or can be formed as an optical, acoustic and/or haptic output module. The output module can be formed as a supplement e.g. to the acoustic output. The output module is preferably formed at least partially as a display and/or partially as a speaker. The maintenance recommendation can be output e.g. as an acoustic alarm sound. As a supplement or alternative, the maintenance recommendation can be formed as an optical alarm signal. An advantageously optical and/or acoustic maintenance recommendation can thus also be output, in particular as a supplement to a data-processing message or notification to a superordinate system.

Moreover, it is proposed that the sensor arrangement and the evaluation device detect a plurality of successive chain links for wear identification in sections. The sensor arrangement is preferably formed to monitor the energy chain continuously or constantly during a movement or during operation of the energy chain, in particular to detect the at least one feature of the chain links continuously on the chain links. An advantageously permanent monitoring of the chain links can be achieved.

In addition, a method or a process is proposed for indirect wear identification on the energy chain.

The process starts from a process for indirect wear identification on an energy chain, for guiding at least one line, such as e.g. a cable, hose or the like, between a stationary fixed point and a driver mobile relative thereto, wherein the energy chain is movable, forming a stationary lower run, a movable upper run and, in between, a deflecting arc, and the energy chain is in particular implemented and arranged with a sliding upper run, wherein a sensor arrangement preferably arranged stationary is provided and an evaluation device, which is signal-connected to the sensor arrangement, is provided.

It is proposed that the sensor arrangement comprises at least two sensors, which are in each case arranged and set up such that, depending on at least one feature which occurs repeating periodically, in particular corresponding to the chain pitch of the energy chain, during movement of the energy chain relative to the sensor arrangement, the sensors generate corresponding output signals, that in at least one process step, depending on at least one such feature which occurs or is detectable repeating periodically, in particular corresponding to the chain pitch of the energy chain, during movement of the energy chain relative to the sensor arrangement, corresponding output signals, which are evaluated by the evaluation device, are generated by the sensor arrangement, and that the evaluation device detects and evaluates the temporal behaviour of the output signals of the individual sensors.

In at least one process step, depending on the at least one feature which occurs and in particular is detectable repeating periodically, in particular corresponding to the chain pitch of the energy chain, during movement, in particular scheduled travelling, of the energy chain relative to the sensor arrangement, corresponding output signals, which are evaluated by the evaluation device, are preferably generated by the sensor arrangement. In at least one process step the energy chain moving past the sensor arrangement is preferably monitored by the sensor arrangement. In at least one process step an output signal is preferably generated by the sensor arrangement every time the at least one feature is detected on a chain link. In at least one process step at least every output signal is preferably sent to the evaluation device. In at least one process step a continuous output signal, which adopts a defined value depending on a presence of the at least one feature and otherwise adopts a base value, is preferably sent to the evaluation device.

Moreover, it is proposed that the sensors are arranged spaced apart from each other in the movement direction and in at least one process step the presence of passing cross bars of the energy chain, in particular as the at least one feature, is detected by each sensor of the sensor arrangement and a corresponding output signal is output. A detection, advantageously uninterrupted for a long period, of the at least one feature of the energy chain can be achieved.

Moreover, it is proposed that in at least one process step capacitive proximity sensors are used as the sensors of the sensor arrangement. An advantageously rapid, in particular high-resolution, monitoring of the energy chain can be achieved.

Furthermore, it is proposed that the at least two sensors of the sensor arrangement detect a feature which is dependent on the chain pitch. A third sensor can preferably be provided, the output signal of which is utilized, e.g. directly or indirectly, for identifying the direction of travel.

Preferably, in at least one process step at least two sensors of the sensor arrangement are used and/or two sensors of the sensor arrangement which are arranged at a distance corresponding to the nominal (like-new) chain pitch are used. Two chain links can be detected simultaneously in order to be able to monitor a distance between the two chain links advantageously.

Moreover, it is proposed that in at least one process step the sensor arrangement which is arranged stationary next to the fixed point in the movement direction of the energy chain is used. An advantageous monitoring of the upper run during movement of the energy chain can be achieved.

Moreover, it is proposed that in at least one process step the evaluation device detects the instantaneous velocity of individual chain links from the temporal behaviour of the output signals of individual sensors. Preferably, in at least one process step the temporal behaviour of the output signals of the sensor arrangement, in particular of individual sensors, is detected by the evaluation device and/or the instantaneous velocity of individual chain links is detected by the evaluation device from the output signals. Preferably, in at least one process step the instantaneous velocity of individual chain links is determined by the evaluation device from the temporal behaviour of the output signals, in particular of individual sensors, of the sensor arrangement. Preferably, in at least one process step the distances, in particular speed-standardized, of individual chain links from each other are determined by the evaluation device from the output signals, and in particular from the temporal behaviour of the output signals, in particular of individual sensors, of the sensor arrangement. An advantageously rapid, in particular high-resolution, monitoring of the energy chain can be achieved.

Furthermore, it is proposed that in at least one process step the output signals of the sensor arrangement, in particular of individual sensors, are evaluated for deviations from a prestored behaviour of a like-new energy chain by the evaluation device. Preferably, in at least one process step at least one distance, preferably speed-standardized, of individual chain links from each other is compared with prestored distances of a like-new energy chain by the evaluation device. A monitoring, advantageously independent of speed, of the wear of an energy chain can be achieved, in particular on the chain links most at risk according to experience.

Moreover, it is proposed that in at least one process step the distance between successive chain links is determined by the evaluation device by measuring time intervals between the periodic feature being detected and with reference to an instantaneous velocity detected in each case and is preferably compared with a predetermined, nominal chain pitch for the purpose of wear identification. An advantageously rapid determination of malfunctions of the energy chain can be achieved.

Furthermore, it is proposed that in at least one process step a maintenance recommendation is output by the evaluation device depending on the evaluation, in particular as a function of a currently detected distance between periodic features. An advantageously optical and/or acoustic maintenance recommendation can be output.

Moreover, it is proposed that in at least one process step a plurality of successive chain links are detected by sensor arrangement and evaluation device for wear identification in sections. An advantageously permanent monitoring of the chain links can be achieved. Further details and advantages of the individual aspects of the invention can be learnt, without limiting the generality of the above, from the following explanation of preferred embodiment examples with reference to the accompanying drawings.

### BRIEF DESCRIPTION OF THE DRAWINGS

Features with corresponding or identical structure or function have corresponding reference numbers and are, where appropriate, not described repeatedly. There are shown in:

FIG. 1: a side view of an energy chain with sliding upper run;

FIG. 2: a perspective view of a preferred embodiment example of a system with a sensor arrangement with several sensors which detect the presence of passing cross bars of the energy chain;

FIG. 3: schematically, a sensor arrangement for several sensors with a hole pattern for different chain types;

FIGS. 4A-4D: show the temporal behaviour of the individual sensors in the case of a passing energy chain; and

FIG. 5: shows, schematized, a process according to the invention.

### DETAILED DESCRIPTION

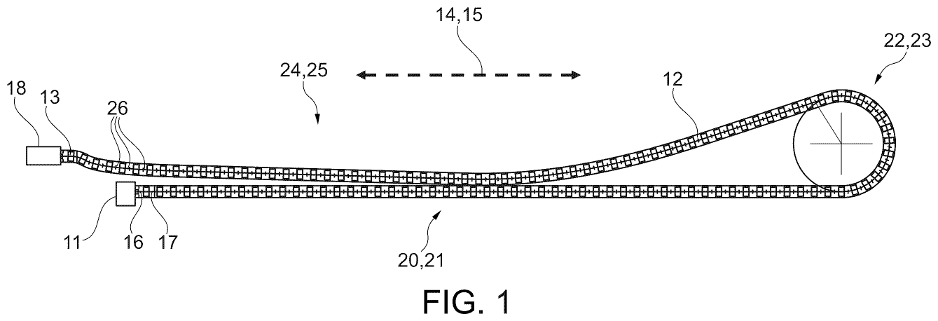

FIGS. 1-4 show an implementation for executing the basic principle for determining wear, e.g. using increasing play between pin and hole in the articulated connection of the chain links by calculating the difference in distance of the opening bars or cross bars between pulling and pushing movements of the energy chain. The opening bar distance corresponds to the time between identification of two opening bars at the measured instantaneous velocity. FIG.1 shows an energy chain 12 (EFK for short below). One end 13 of the EFK 12 is mobile along a longitudinal axis 14 of the EFK 12, in particular movable back and forth, in particular with respect to at least one further end 17 of the EFK 12. A stationary fixed point 16 of the EFK 12 is arranged at one end 17 of the EFK 12. A driver 18 of the EFK 12 is arranged at the other end 13 of the EFK 12. The driver 18 forms one end 13 of the EFK 12. The EFK 12 is arranged in such a way that during movement of the driver 18 of the EFK 12 the EFK 12 forms at least three different areas 20, 22, 24, which in the example shown correspond to the lower run, the deflecting arc and upper run.

One of the three areas 20, 22, 24 is a stationary lower run 21, which extends from the end 17 of the EFK 12 at which the stationary fixed point 16 is arranged to a deflecting arc 23 and which is formed by a part of the EFK 12 extending parallel to the longitudinal axis 14 of the EFK 12. The area 20 of the EFK 12 which forms the stationary lower run 21 is formed stationary only in relation to the end 17 at which the stationary fixed point 16 is arranged. One of the three areas 20, 22, 24 is a movable upper run 25, which extends from the end 13 of the EFK 12 at which the driver 18 is arranged to the deflecting arc 23 and which is formed by a part of the EFK 12 extending parallel to the longitudinal axis 14 of the EFK 12. The upper run 25 is mounted sliding on the lower run 21. One of the three areas 20, 22, 24 is a deflecting arc 23 which is arranged between the stationary lower run 21 and the movable upper run 25 and which forms a 180° arc of the EFK 12.

However, the invention is also readily applicable to an EFK 12 with movable lower run 21 and stationary upper run 25.

To guide one or more line(s), such as cables, hoses or the like, the EFK 12 has a very widely known structure. The EFK 12 comprises a plurality of chain links 26, which are connected to each other in an articulated manner transverse to the longitudinal axis 14. By way of example, only three chain links 26 are provided with a reference number. The EFK 12 has a mobile end 13, at which the driver 18 is arranged. The EFK 12 has a fixed chain end 25, which is fixedly flange-mounted on a usually spatially fixed base 11 of an outer carrier structure. In an active state the driver 18 moves back and forth, for example along the longitudinal axis 14, in particular to the left and to the right in FIG. 1, relative to the stationary fixed point 16. The driver 18 is e.g. a mobile connection point in a machine, which is to be supplied with energy, data and/or media. The base 11 usually forms the fixed connection point. The driver 18 could alternatively also be vertically mobile or mobile along two axes. The EFK 12 forms a deflecting arc 23, which moves with it corresponding to the driver movement. The deflecting arc 23 is defined e.g. via a deflection roller, or usually by angle-limiting stops of the chain links 26.

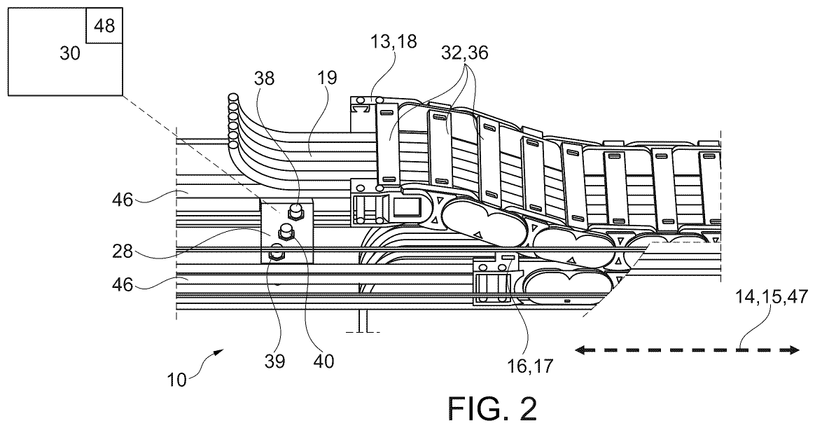

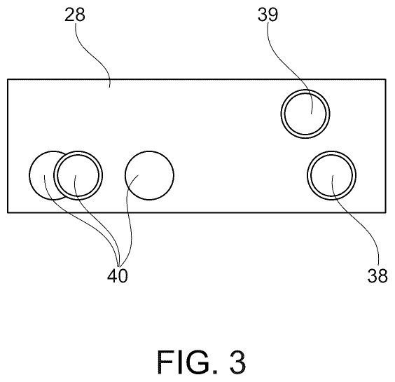

FIG. 2 shows, as a schematic diagram, a system, generally labelled 10, for indirect wear identification on the EFK 12. The system 10 comprises as main constituents: an EFK 12, an evaluation device 30 and a sensor arrangement 28 arranged on the EFK 12. The arrangement of the three sensors 18, 18′, 18″ of the sensor arrangement 28 is purely by way of example in FIG. 2. The arrangement of the three sensors 18, 18′, 18″ of the sensor arrangement 28 is described more precisely in FIG. 3. The sensor arrangement 28 is signal-connected to the evaluation device 30.

FIG. 2 shows in particular the system for indirect wear identification on the EFK 12. The EFK 12 is formed to guide at least one line 19, such as e.g. a cable, hose or the like. The EFK 12 is formed to guide at least one line 19 between the stationary fixed point 16 and a driver 18 mobile relative thereto. The EFK 12 is movable, forming a stationary lower run 21, a movable upper run 25 and, in between, a deflecting arc 23. The EFK 12 is implemented and arranged as on the lower run 21 sliding upper run 25.

The system 10 has a sensor arrangement 28 arranged stationary and an evaluation device 30, which is signal-connected to the sensor arrangement, wherein the sensor arrangement is arranged and set up to generate, depending on at least one feature which occurs, in particular is detectable, repeating periodically, in particular corresponding to the chain pitch of the EFK 12, during movement, in particular travelling, of the EFK 12 relative to the sensor arrangement, corresponding output signals, which the evaluation device evaluates. The system 10 is formed for indirect wear identification on the chain links 26 of the EFK 12. The EFK 12 has by way of example over twenty chain links 26, which are all formed structurally identical. The system 10 is formed for indirect wear identification of a wear of the EFK 12, between the stationary fixed point 16 of the EFK 12 and a driver 18 of the EFK 12 mobile relative thereto.

The system 10 has the sensor arrangement 28 arranged stationary with respect to the EFK 12. The system 10 has the evaluation device 30. The evaluation device 30 is signal-connected to the sensor arrangement 28 for a data transmission from the sensor arrangement 28 to the evaluation device 30.

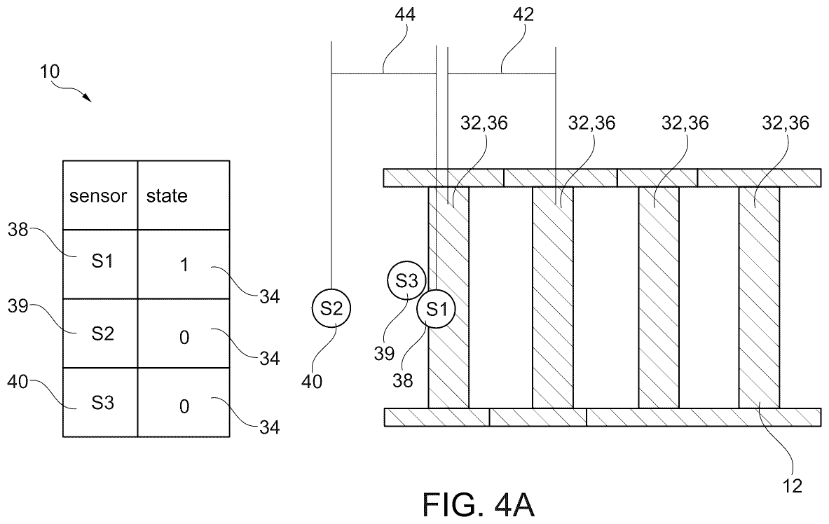

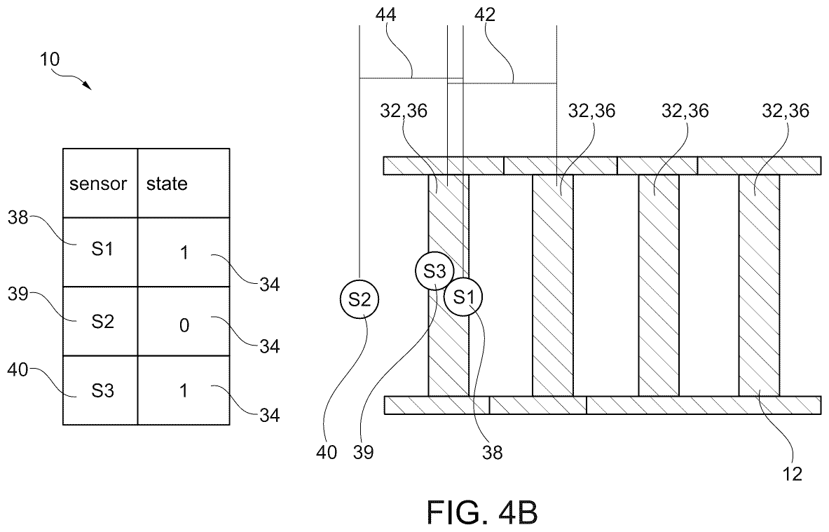

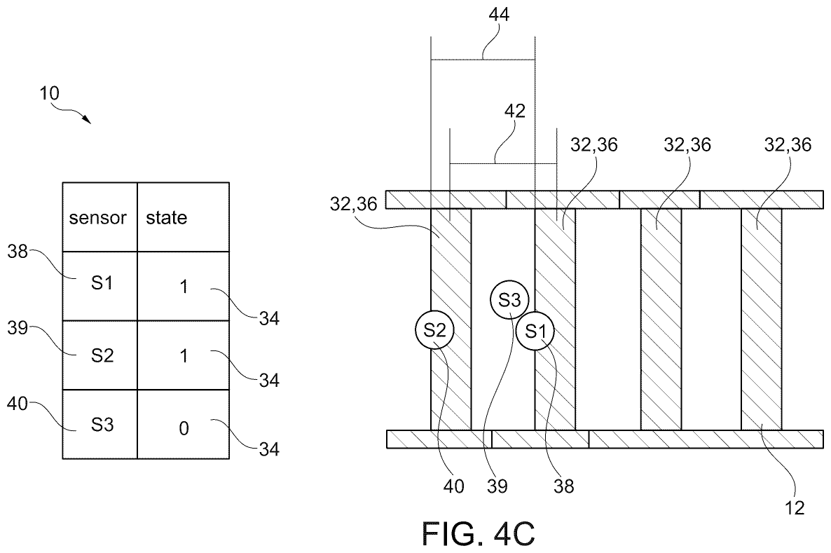

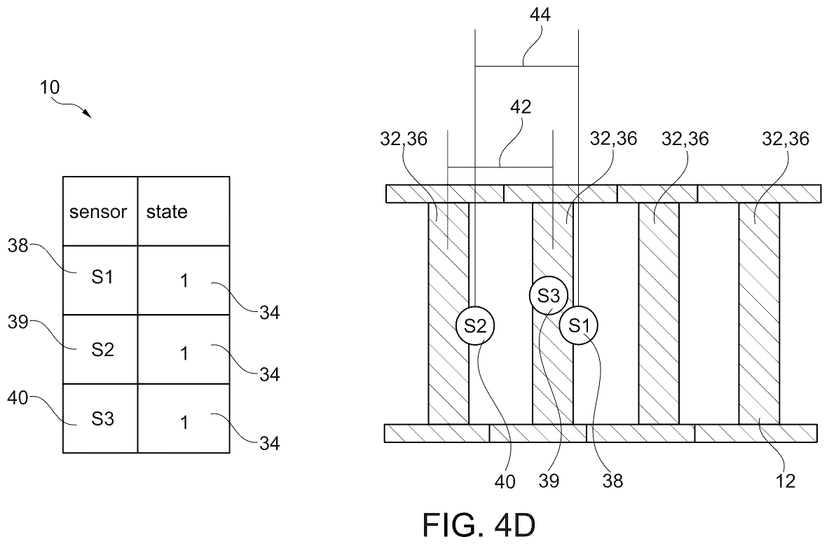

The sensor arrangement 28 transmits, for example, a continuous signal to the evaluation device 30, for example in real time or as a periodic signal with a transmission frequency of at least 20 Hz. The sensor arrangement 28 is arranged and set up to generate, depending on at least one feature 32 of the EFK 12, corresponding output signals 34, which the evaluation device 30 evaluates (cf. FIGS. 4A to 4D).

The sensor arrangement 28 is set up to generate, depending on at least one feature of the EFK 12, corresponding output signals 34 and to send them to the evaluation device 30. The feature 32 of the EFK 12 occurs repeating periodically, in particular corresponding to the chain pitch of the EFK 12, during movement, in particular travelling, of the EFK 12 relative to the sensor arrangement 28. The feature 32 of the EFK 12 is a feature 32 which occurs on every chain link 26 of the EFK 12, in particular in each case at the same point on the chain links 26. The feature 32 of the EFK 12 is detectable repeating periodically, in particular corresponding to the chain pitch of the EFK 12, during movement, in particular travelling, of the EFK 12 relative to the sensor arrangement 28. For example, the feature 32 of the EFK 12 is formed as a respective lower element of the chain links 26. The feature 32 of the EFK 12 here is formed by way of example as a cross bar 36 on the chain links 26. The sensor arrangement 28 is formed to monitor the EFK 12, in particular the feature 32 of the EFK 12, preferably of every chain link 26 of the EFK 12, during movement of the EFK 12. The sensor arrangement 28 has three sensors 38, 39, 40, which are formed to detect the feature 32 of the EFK 12 during movement of the EFK 12. The sensors 38, 39, 40 are implemented as capacitive proximity sensors. The sensors 38, 39, 40 of the sensor arrangement 28 are all formed functionally identical and structurally identical.

The evaluation device 30 is formed to determine a distance 42 between two chain links 26 of the EFK 12 from the output signals 34 which the evaluation device 30 receives from the sensor arrangement 28 (cf. FIGS. 4A-4D). The evaluation device 30 is formed to determine an instantaneous velocity, for example, of individual chain links 26 of the EFK 12 from the output signals 34 which the evaluation device 30 receives from the sensor arrangement 28. The evaluation device 30 is formed to standardize the determined distances 42 between in each case two chain links 26 by means of determined instantaneous velocities of the chain links 26. The evaluation device 30 is formed to determine a wear condition of the EFK 12, in particular of the chain links of the EFK 12, from determined, in particular standardized, distances 42 of the chain links 26 of the EFK 12. The evaluation device 30 can additionally be formed to determine a change in the instantaneous velocity of the chain links 26 of the EFK 12 from the output signals 34 which the evaluation device 30 receives from the sensor arrangement 28. The evaluation device 30 can additionally be formed to determine a wear condition of the EFK 12, in particular of the chain links of the EFK 12, from determined changes in the instantaneous velocity of the chain links 26 of the EFK 12.

The sensor arrangement 28 comprises several sensors 38, 39, 40 spaced apart from each other in the movement direction 15 of the EFK 12, in particular along the longitudinal axis 14 of the EFK 12, and is arranged such that each of the sensors 38, 39, 40 detects the presence of passing cross bars 36 of the EFK 12, in particular as the at least one feature 32 of the EFK 12, and outputs a corresponding output signal 34.

The sensor arrangement 28 comprises three sensors 38, 39, 40, which are arranged spaced apart from each other in the movement direction 15 of the EFK 12, in particular along the longitudinal axis 14 of the EFK 12, in particular of which two are arranged partially offset relative to each other in the movement direction 15 of the EFK 12 and of which one is arranged completely offset with respect to the others in the movement direction 15 of the EFK 12. The movement direction 15 of the EFK 12 is aligned parallel to the longitudinal axis 14 of the EFK 12.

Each of the sensors 38, 39, 40 detects the presence of the feature 32 of the EFK 12, for example of passing cross bars 36. Each of the sensors 38, 39, 40 outputs an output signal 34 corresponding to the detected presence or absence of the feature 32 of the EFK 12, for example of the passing cross bar 36 (cf. FIGS. 4A-4D).

At least two sensors 38, 39, 40 are provided and/or two sensors 38, 39, 40 are arranged at a distance corresponding to the nominal, in particular in relation to a like-new, chain pitch (cf. FIGS. 3, 4A-4D). The sensor arrangement 28 has at least two sensors 38, 40, which are arranged offset relative to each other along the movement direction 15, in particular along the longitudinal axis 14 of the EFK 12, at a distance 44 corresponding to the nominal, in particular in relation to a like-new, chain pitch. For one sensor 40 of the three sensors 38, 39, 40, different connection interfaces are provided on the sensor arrangement, depending on what type of energy chain the sensor arrangement 28 is to monitor. The three sensors 38, 39, 40 are arranged offset relative to each other in such a way that when the EFK travels over the sensor arrangement 28 a sensor always generates an output signal which differs from the base signal. Here, the base signal is formed by way of example as “0” and the output signal as “1”. Here, the signal, in particular output signal, of the sensors 38, 39, 40 is formed binary by way of example.

The system 10 has, for example, the EFK 12 for indirect wear identification on the EFK 12. Geometric centres of two sensors 38, 40 are arranged offset relative to each other along the movement direction 15, in particular along the longitudinal axis 14 of the EFK 12, at a distance 44 corresponding to the nominal, in particular in relation to a like-new, chain pitch (cf. FIGS. 4A-4D).

The sensor arrangement 28 is arranged stationary next to the fixed point 16 in the movement direction 15 of the EFK 12. The sensor arrangement 28 is connected stationary to the carrier structure, in particular a rail unit 46 (cf. FIG. 2). The sensor arrangement 28 is arranged stationary next to the fixed point 16 for monitoring the upper run 25 of the EFK 12 in the movement direction 15 of the EFK 12. The stationary fixed point 16 of the EFK 12 is arranged on the lower run 21 of the EFK 12. The sensor arrangement 28 is arranged offset relative to the stationary fixed point 16 in the movement direction 15 of the EFK 12, in particular along the longitudinal axis 14 of the EFK 12. The rail unit 46 has two rails which are aligned parallel to the longitudinal axis 14 of the EFK 12, on which the EFK 12 is mounted and to which the sensor arrangement 28 is connected. The stationary fixed point 16 of the EFK 12 is connected to the rail unit 46 offset relative to the sensor arrangement 28 along a longitudinal axis 47 of the rail unit.

The evaluation device 30 is formed to detect, in particular to determine, the temporal behaviour of the output signals 34 of the sensor arrangement 28, in particular of individual sensors 38, 39, 40, and/or to detect, in particular to determine, the instantaneous velocity of individual chain links 26 from the output signals 34.

The evaluation device 30 is formed to determine a wear condition of a connection of the two chain links 26 from the distances 42, in particular in combination with the instantaneous velocities, of two neighbouring chain links 26. The evaluation device 30 is formed to evaluate the output signals 34 of the sensor arrangement 28 for deviations from a prestored behaviour of a like-new EFK 12. The evaluation device 30 has a memory module, on which data with guide values which correspond to a like-new EFK 12 are stored, in particular prestored. The evaluation device 30 is formed to determine the distance 42 between successive chain links 26 by measuring time intervals between the periodic feature 32 being detected and with reference to an instantaneous velocity detected in each case and preferably to correlate this with a predetermined, nominal chain pitch for the purpose of wear identification. The evaluation device 30 is formed to determine the standardized distance 42 between successive chain links 26 by measuring time intervals between the periodic feature 32 being detected and with reference to an instantaneous velocity detected in each case. The evaluation device 30 is formed to correlate each determined, and in particular standardized, distance 42 with a predetermined, nominal chain pitch for wear identification on the corresponding chain links 26.

The evaluation device 30 is formed to output a maintenance recommendation depending on the evaluation, in particular as a function of a currently detected distance 42 between periodic features 32. The evaluation device 30 has an output module 48, which is formed as an optical and acoustic output module 48. The output module 48 is formed partially as a display and partially as a speaker. The maintenance recommendation is formed partially as an acoustic alarm sound. The maintenance recommendation is formed partially as an optical alarm signal.

The sensor arrangement 28 and the evaluation device 30 are formed to detect a plurality of successive chain links 26 for wear identification in sections. The sensor arrangement 28 is formed to monitor the EFK 12, in particular to detect the at least one feature 32 of the chain links 26, constantly during a movement of the EFK 12.

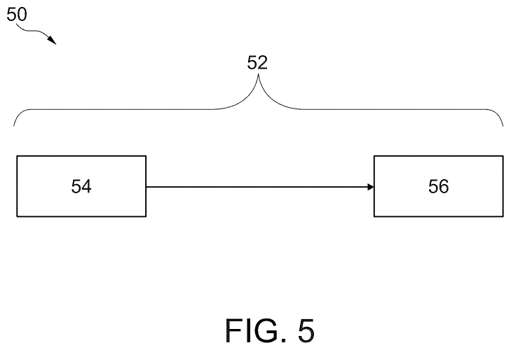

FIG.5 shows, schematized, an example of a sequence of the process 50 for indirect wear identification on an EFK 12.

The process 50 has a single continuous process step 52 as the important step. For the sake of the simplicity of the explanation, process steps repeating simultaneously and repetitively or permanently in the continuous process step 52 are explained as two individual substeps in an example sequence in the following.

In one process step, in particular a detection step 54, the EFK 12 moving past the sensor arrangement 28 is monitored by the sensor arrangement 28. In one process step, in particular the detection step 54, an output signal 34 is generated by the sensor arrangement 28 every time the feature 32 is detected on a chain link 26. In one process step, in particular a detection step 54, each output signal generated is sent to the evaluation device 30. In one process step, in particular a detection step 54, a continuous output signal 34, which adopts a defined value, for example “1”, depending on a presence of the feature 32 and otherwise adopts a base value, for example “0”, is sent to the evaluation device 30. In one process step, in particular a detection step 54, capacitive proximity sensors are used as the sensors 38, 39, 40 of the sensor arrangement 28. In one process step, in particular a detection step 54, the presence of passing cross bars 36 of the EFK 12, in particular as the feature 32, is detected by each sensor 38, 39, 40 of the sensor arrangement 28 and a corresponding output signal 34 is output. In one process step, in particular a detection step 54, at least two sensors 38, 39, 40 of the sensor arrangement 28 are used and/or two sensors 38, 39, 40 of the sensor arrangement 28, which are arranged at a distance 44 corresponding to the nominal (like-new) chain pitch, are used. In one process step, in particular a detection step 54, the sensor arrangement 28, which is arranged stationary next to the fixed point 16 in the movement direction 15 of the EFK 12, is used.

In one process step, in particular an evaluation step 56, the temporal behaviour of the output signals 34 of the sensor arrangement 28, in particular of individual sensors 38, 39, 40, is detected by the evaluation device 30 and/or the instantaneous velocity of individual chain links 26 is detected by the evaluation device 30 from the output signals 34. In one process step, in particular the evaluation step 56, the instantaneous velocity of individual chain links 26 is determined by the evaluation device 30 from the temporal behaviour of the output signals 34, in particular of individual sensors 38, 39, 40, of the sensor arrangement 28. In one process step, in particular an evaluation step 56, the distances 42, in particular speed-standardized, of individual chain links 26 from each other are determined by the evaluation device 30 from the output signals 34, and in particular from the temporal behaviour of the output signals 34, in particular of individual sensors 38, 39, 40, of the sensor arrangement 28. In one process step, in particular an evaluation step 56, the output signals 34 of the sensor arrangement 28 are evaluated for deviations from a prestored behaviour of a like-new EFK 12 by the evaluation device 30. In one process step, in particular an evaluation step 56, at least one distance 42, preferably speed-standardized, of individual chain links 26 from each other is compared with prestored distances 44 of a like-new EFK 12 by the evaluation device 30. In one process step, in particular an evaluation step 56, the distance 42 between successive chain links 26 is determined by the evaluation device 30 by measuring time intervals between the periodic feature 32 being detected and with reference to an instantaneous velocity detected in each case and is in particular compared with a predetermined, nominal chain pitch for the purpose of wear identification. In one process step, in particular an evaluation step 56, a maintenance recommendation is output by the evaluation device 30 depending on the evaluation, in particular as a function of a currently detected distance 42 between periodic features 42.

In one process step, in particular an evaluation step 56, a plurality of successive chain links 26 will be detected by sensor arrangement 28 and evaluation device 30 for wear identification in sections.

In one process step, in particular the continuously repeating step 52, depending on the at least one feature which occurs and in particular is detectable repeating periodically, in particular corresponding to the chain pitch of the EFK 12, during movement, in particular scheduled travelling, of the EFK 12 relative to the sensor arrangement 28, corresponding output signals, which are evaluated by the evaluation device 30, are generated by the sensor arrangement 28.

### LIST OF REFERENCE NUMBERS

10 system
11 base
12 energy chain (EFK)
13 end
14 longitudinal axis
15 movement direction
16 fixed point
17 end
18 driver
20 area
21 lower run
22 area
23 deflecting arc
24 area
25 upper run
26 chain link
28 sensor arrangement
30 evaluation device
32 feature
34 output signal
36 cross bar
38 sensor
39 sensor
40 sensor
42 distance
44 distance
46 rail unit
48 output module
50 process
52 continuous process step
54 detection step
56 evaluation step

What is claimed is:

1-20. (canceled)

21. A system for indirect wear identification on an energy chain, for guiding at least one line, such as e.g. a cable, hose or the like, between a stationary fixed point and a driver mobile relative thereto, wherein the energy chain is movable, forming a stationary lower run, a movable upper run and, in between, a deflecting arc, and the energy chain is in particular implemented and arranged with a sliding upper run, the system comprising a sensor arrangement preferably arranged stationary and an evaluation device, which is signal-connected to the sensor arrangement, wherein:
the sensor arrangement comprises at least two sensors, which are in each case arranged and set up such that, depending on at least one feature which occurs or is detectable repeating periodically, in particular corresponding to the chain pitch of the energy chain, during movement of the energy chain relative to the sensor arrangement, each of the sensors respectively detecting the presence of the at least one feature of the energy chain, the sensors generate corresponding output signals, which the evaluation device evaluates; and
the evaluation device is set up in order to detect and evaluate the temporal behavior of the output signals of the individual sensors.

22. The system according to claim 21, wherein the sensors are spaced apart from each other in the movement direction, and arranged and set up such that each of the sensors detects the presence of passing cross bars of the energy chain and outputs a corresponding output signal.

23. The system according to claim 22, wherein the sensors are implemented as capacitive proximity sensors.

24. The system according to claim 22, wherein at least two sensors of the sensor arrangement are arranged at a distance corresponding to the nominal (like-new) chain pitch and/or are arranged and set up to detect a feature which is dependent on the chain pitch.

25. The system according to claim 22, wherein the sensor arrangement is arranged stationary next to the fixed point in the movement direction of the energy chain.

26. The system according to claim 21, wherein:
the evaluation device detects the instantaneous velocity of individual chain links from the temporal behavior of the output signals; and/or
the evaluation device comprises three sensors, wherein two sensors of the sensor arrangement are arranged at a distance corresponding to the nominal chain pitch and a third sensor is provided for identifying the direction of travel.

27. The system according to claim 26, wherein the evaluation device evaluates the output signals of the sensor arrangement for deviations from a prestored behavior of a like-new energy chain.

28. The system according to claim 21, wherein the evaluation device determines the distance between successive chain links by measuring time intervals between the periodic feature being detected and with reference to an instantaneous velocity detected in each case and preferably compares this with a predetermined, nominal chain pitch for the purpose of wear identification.

29. The system according to claim 28, wherein the evaluation device outputs a maintenance recommendation depending on the evaluation, in particular as a function of a currently detected distance between periodic features.

30. The system according to claim 21, wherein sensor arrangement and evaluation device detect a plurality of successive chain links for wear identification in sections.

31. A process for indirect wear identification on an energy chain, for guiding at least one line, such as a cable or hose, between a stationary fixed point and a driver mobile relative thereto, wherein the energy chain is movable, forming a stationary lower run, a movable upper run and, in between, a deflecting arc, and the energy chain is in particular implemented and arranged with a sliding upper run, wherein a sensor arrangement preferably arranged stationary is provided and an evaluation device, which is signal-connected to the sensor arrangement, is provided, wherein:
the sensor arrangement comprises at least two sensors, which are in each case arranged and set up such that, depending on at least one feature which occurs repeating periodically, in particular corresponding to the chain pitch of the energy chain, during movement of the energy chain relative to the sensor arrangement, each of the sensors respectively detecting the presence of the at least one feature of the energy chain, the sensors generate corresponding output signals;
in at least one process step, depending on at least one such feature which occurs or is detectable repeating periodically, in particular corresponding to the chain pitch of the energy chain, during movement of the energy chain relative to the sensor arrangement, corresponding output signals, which are evaluated by the evaluation device, are generated by the sensor arrangement; and
the evaluation device detects and evaluates the temporal behavior of the output signals of the individual sensors.

32. The process according to claim 31, wherein the sensors are arranged spaced apart from each other in the movement direction and in at least one process step the presence of passing cross bars of the energy chain, in particular as the at least one feature, is detected by each sensor of the sensor arrangement and a corresponding output signal is output.

33. The process according to claim 32, wherein in at least one process step capacitive proximity sensors are used as the sensors of the sensor arrangement.

34. The process according to claim 32, wherein the at least two sensors of the sensor arrangement detect a feature which is dependent on the chain pitch and a third sensor is preferably provided, the output signal of which is utilized for identifying the direction of travel.

35. The process according to claim 32, wherein the sensor arrangement is arranged stationary next to the fixed point in the movement direction of the energy chain.

36. The process according to claim 31, wherein in at least one process step the evaluation device detects the instantaneous velocity of individual chain links from the temporal behavior of the output signals of individual sensors.

37. The process according to claim 33, wherein in at least one process step the output signals of the sensor arrangement, in particular of individual sensors, are evaluated for deviations from a prestored behavior of a like-new energy chain by the evaluation device.

38. The process according to claim 31, wherein in at least one process step the distance between successive chain links is determined by the evaluation device by measuring time intervals between the periodic feature being detected and with reference to an instantaneous velocity detected in each case and is preferably compared with a predetermined, nominal chain pitch for the purpose of wear identification.

39. The process according to claim 38, wherein in at least one process step a maintenance recommendation is output by the evaluation device depending on the evaluation, in particular as a function of a currently detected distance between periodic features.

40. The process according to claim 31, wherein in at least one process step a plurality of successive chain links are detected by sensor arrangement and evaluation device for wear identification in sections.
